(19) United States
(12) Patent Application Publication
(10) Pub. No.: US 2016/0301450 A1
(43) Pub. Date: Oct. 13, 2016

(54) Proximity Identification Device with Improved Orientation Features and User Feedback

(71) Applicant: Creating Revolutions LLC, Miami, FL (US)

(72) Inventor: Einar Rosenberg, Miami, FL (US)

(21) Appl. No.: 14/995,043

(22) Filed: Jan. 13, 2016

Related U.S. Application Data
(60) Provisional application No. 62/103,050, filed on Jan. 13, 2015.
(60) Provisional application No. 62/106,360, filed on Jan. 22, 2015.

(51) Int. Cl. H04B 5/00; H04W 4/02

(52) U.S. Cl. CPC H04B 5/0062; H04W 4/026

(57) ABSTRACT

A close proximity communication tag device that provides an indicator that a mobile communication device is substantially correctly oriented and placed with the respect to the tag device for communications.

### CROSS REFERENCE TO RELATED APPLICATIONS

This application claims the benefit of U.S. provisional patent application No. 62/103,050, filed Jan. 13, 2015 and U.S. provisional patent application No. 62/106,360, filed Jan. 22, 2015, the disclosures of which are incorporated herein by reference in their entirety.

### FIELD OF THE INVENTION

This invention relates to the field of radio communications and more specifically to close proximity communications, including, but not limited to near field communications and Bluetooth communications.

### BACKGROUND OF THE INVENTION

As time progresses, more and more people are using mobile communication devices to perform tasks, including but limited to, surfing the Internet, sending e-mails and texts, and making payments. With the advent of mobile payment systems, for example Android Pay or Applepay, combined with the relatively easy ability to use, it likely that many if not most future payments for goods and services, will be made using a mobile payment system. Many mobile payment systems rely on close proximity communications (“close proximity communication”), e.g., near field communications (“NFC”), Bluetooth Low Energy (“BLE”); communications with a communication range of only a few inches—hence the intended communicating devices need to be in close proximity to carry out communications. Close proximity communication tags, i.e., close proximity communication devices that typically provide only limited information, but can provide sufficient information to enable effective use.

Close proximity communication is also used in other situations, for example, in situations where information is sought to be communicated short distances to a mobile communication device. For example, in Touch and Discover™ and other information accessing scenarios, a mobile communication device is used to receive contactless information from an NFC tag, the mobile communication device interprets the received information and a designated website or application opens on the mobile communication device.

### SUMMARY

Having examined and understood a range of previously available devices, the inventor of the present invention has developed a new and important understanding of the problems associated with the prior art and, out of this novel understanding, has developed new and useful solutions and improved devices, including solutions and devices yielding surprising and beneficial results.

In particular, the inventor has come to understand that the adoption of a new technology is often as much dependent upon the psychological interaction that the technology, in its physical embodiment, promotes with a user, as upon the underlying technical function of a device. It may well be observed that, in consequence of this fact, many otherwise interesting and novel technologies have failed to achieve commercial or popular success because they are insufficiently attractive or otherwise failed to provide a useful interaction with potential uses.

The reader will appreciate that, while some design features are relevant to this interaction between technology and user, the totality of making a product attractive and accepted often involves the development and integration of important technical features that fully integrate with both design and functionality and without which design aspects would not be practical, or even possible.

The present invention offers examples of technical and human factors features involving important novelty, and opening a vast array of new opportunities to nascent technologies. In particular, the instant invention presents certain devices, apparatus, methods and systems valuable in transactional and service industry applications of various communications modalities including, among others and without limitation, Near Field Communication (NFC) electronic data channels.

As an exemplary embodiment, and with the understanding that this is only one of many possible applications of the present invention, the present application describes in substantial detail (sufficient for one of ordinary skill in the art to readily practice the same with a minimum of experimentation) a consumer interaction disc including novel features arranged and configured to facilitate and promote interaction between a user and an underlying communication system. Among these features are examples that promote a desirable spatial interface between a handheld device of a user and a sensing region of the token, and certain feedback mechanisms that tend to reward and encourage a desirable and effective interaction.

It will be understood by one of skill in the art that, while the exemplary embodiment primarily described here with is referred to as a “disc” and is generally circular in certain aspects, a wide variety of other geometric configurations that nevertheless include the described novel features will fall within the scope of the invention. Accordingly, in certain embodiments, the present invention includes a close proximity communications device that is configured and arranged to encourage a user to establish effective communications between the device and the user's handheld electronic device. Among other aspects, and in particular embodiments, this configuration and arrangement includes the provision of a device contact surface disposed in space relation to an underlying supporting surface (such as a tabletop) and sensory feedback effective to indicate to the user that a desirable communication status has been successfully established. In a still further aspect, certain embodiments of the invention will include a close proximity communication device which incorporates a power source. In certain embodiments, this power source will include an electrochemical battery. Of the various embodiments, many will include a switching device effective to disconnect the power source from operative circuitry of the communication device. Consequently, an effective lifetime of the power supply (and therefore of the device as a whole), will be substantially extended (as compared with devices lacking this feature).

The inventor observed that virtually all smartphones, and many other personal electronic devices, include a microphone and a speaker. Characteristic of the vast majority of these microphones and speakers is that they each include a permanent magnet. While these permanent magnets are provided in their respective apparatus solely for their role in establishing a state or field for the respective transducers, the present inventor has realized that, surprisingly, the resulting magnetic field provide an additional and previously unexploited benefit. Specifically, these permanent magnets can be used to interact with an external sensor. Among other benefits, this interaction allows an external sensor to be arranged that is effective to switch a power supply of, for example, a close proximity communication device of the invention. As a result, active communications modalities (such as, without limitation, Bluetooth) can be employed while in a way that results in an extraordinary lifetime for a given power supply. In addition, power switching based on the sensing of magnetic or other device proximity, can be used to provide sensory feedback to a user, that is related to both proximity and orientation of a user's electronic device and the close proximity communication device.

In certain embodiments, the system employs a sensor that senses when a mobile communication device is correctly oriented and positioned with respect to the sensor. In an approach, a magnetic switch is employed as a sensor that senses a ferrous metal and/or antennae generally located in the upper portion mobile communication device. When the user holds a mobile communication device at an appropriate orientation and distance from the sensor, the magnetic switch will close an electrical circuit. When the circuit is closed, an indicator is made active, for example, a light is illuminated. As such, a user is motivated to place the mobile communication device in an appropriate position and orientation to receive positive feedback from the indicator of the close proximity communication device.

The close proximity communication device also includes a close proximity communication tag for communicating with a mobile communication device. When a mobile communication device's close proximity communication system is appropriately oriented and positioned with respect to the close proximity communication tag, the mobile communication device and the close proximity communication tag will pair. Based on the placement of the close proximity communication device sensor with respect to the close proximity communication tag, when the sensor senses the mobile communication device being in appropriate orientation and position with respect to the sensor, the close proximity communication hardware of the mobile communication device will generally also be in an appropriate orientation and position to pair with the close proximity communication tag of the close proximity communication device.

### BRIEF DESCRIPTION OF THE DRAWINGS

The accompanying drawings, which are incorporated in and form part of the specification, illustrate embodiments of the invention and, together with the description, serve to explain the principles of the invention.

For purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the substance disclosed.

It should be noted that, while the various figures show respective aspects of the invention, no one figure is intended to show the entire invention. Rather, the figures together illustrate the invention in its various aspects and principles. As such, it should not be presumed that any particular figure is exclusively related to a discrete aspect or species of the invention. To the contrary, one of skill in the art would appreciate that the figures taken together reflect various embodiments exemplifying the invention.

Correspondingly, references throughout the specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout the specification are not necessarily all referring to the same embodiment. Furthermore, the particular features, structures, or characteristics may be combined in any suitable manner in one or more embodiments. In the drawings:

FIG. 1 depicts a perspective view of a close proximity device in accordance with an exemplary embodiment of the invention;

FIG. 2 depicts a side, cut away view of the close proximity device of FIG. 1;

FIG. 3 depicts an exemplary communication component housing;

FIG. 4 depicts a top side perspective looking down through a cover of communication component;

FIG. 5 depicts a bottom up view of the cover of the communication component;

FIG. 6 depicts top down perspective view of a bottom portion of a communication component housing;

FIGS. 7-11 depict an exemplary method of forming the communication component;

FIG. 12 depicts an exemplary battery housing component;

FIG. 13 depicts an exemplary housing component;

FIG. 14 depicts an exemplary base component;

FIG. 15 depicts a circuit diagram of the exemplary invention;

FIG. 16 depicts a perspective of an exemplary embodiment of the invention;

FIG. 17 depicts a user placing a mobile communication device over an embodiment of the invention; and

FIG. 18 depicts a slightly exploded, cutaway view of a communication component.

### DETAILED DESCRIPTION OF THE INVENTION

In the following detailed description, reference is made to the accompanying drawings, which form a part hereof, and in which is shown by way of illustration specific exemplary embodiments of the invention.

Having examined and understood a range of previously available devices, the inventor of the present invention has developed a new and important understanding of the problems associated with the prior art and, out of this novel understanding, has developed new and useful solutions and improved devices, including solutions and devices yielding surprising and beneficial results.

In particular, the present inventor has come to understand that the adoption of a new technology is often as much dependent upon the psychological interaction that the technology, in its physical embodiment, promotes with a user, as upon the underlying technical function of a device. It may well be observed that, in consequence of this fact, many otherwise interesting and novel technologies have failed to achieve commercial or popular success because they are insufficiently attractive or otherwise failed to provide a useful interaction with potential uses.

The reader will appreciate that, while some design features are relevant to this interaction between technology and user, the totality of making a product attractive and accepted often involves the development and integration of important technical features that fully integrate with both design and functionality and without which design aspects would not be practical or even possible.

The present invention offers examples of technical and human factors features involving important novelty, and opening a vast array of new opportunities to nascent technologies. In particular, the instant invention presents certain devices, apparatus, methods and systems valuable in transactional and service industry applications of various communications modalities including, among others and without limitation, close proximity communications, including, but not limited to, Near Field Communication (NFC) electronic data channels.

As an exemplary embodiment, and with the understanding that this is only one of many possible applications of the present invention, the present application describes in substantial detail (sufficient for one of ordinary skill in the art to readily practice the same with a minimum of experimentation) a consumer interaction device including particular features arranged and configured to facilitate and promote interaction between a user and an underlying communication system. Among these features are examples that promote a desirable spatial interface between a handheld device of a user and a sensing region of the token, and certain feedback mechanisms that tend to reward and encourage a desirable and effective interaction.

A disadvantage of using close proximity communication is that a user having a close proximity communication enabled mobile communication device generally does not have feedback or an indication that his mobile communication device is close enough and/or properly oriented to another close proximity communication device to enable communications between the two devices. Thus, when using close proximity communication, it would be desirable to have feedback as to whether the user's mobile communication device is correctly oriented and positioned with respect to the device with which it is communicating.

Accordingly, and in light of the foregoing, inventions encompassing these new and useful solutions and improved devices are described below in their various aspects with reference to several exemplary embodiments including a preferred embodiment.

The invention discloses an improved close proximity communication tag device. The close proximity communication tag devices can be provided in a variety of shapes and sizes and materials. In some variations the improved close proximity communication devices contain one or more close proximity communication tags, including, but not limited to, NFC, BLE, RFID, and other wireless near or close proximity technologies. Furthermore, in certain applications, other communication technologies, e.g., Wi-Fi, Li-Fi, etc., may be employed, with or without modification, in the present invention.

In a preferred approach, the CPD devices include several features that make their implementation advantageous over the use of conventional tag devices. In one aspect the CPD devices includes a feature that will determine if a mobile communication device is sufficiently close to the close proximity device and if the mobile communication device is correctly oriented with respect to the close proximity device. If a mobile communication device is sufficiently close and correctly oriented then the close proximity device provides an indication to the user.

An additional feature provides power savings for the close proximity device. As some close proximity communication tags require a power source in order to operate, e.g., BLE, and are generally battery powered, it would be desirable for a close proximity device to reduce the load on the battery when possible. In the present invention, the close proximity device only provides power to a CPc tag when a mobile communication device is sufficiently close and correctly oriented with respect to the close proximity device. Thus when a user places a mobile communication device sufficiently close and sufficiently oriented to the close proximity device, the close proximity device provides power to its close proximity communication tag. When the user subsequently places the mobile communication device such that it is no longer sufficiently close and sufficiently oriented to the close proximity device then the close proximity device no longer provides power to its close proximity communication tag.

A mobile communication device is generally designed to correspond to the typical anatomical features of a person using a phone type devices, having a speaker for providing sounds, i.e., hearing sounds, on one end portion and a microphone on the other end portion for collecting sounds, i.e., talking. In most such devices, the speaker and the microphone each include a respective permanent magnet. The inventor of the present invention has recognized that, surprisingly, a respective magnetic field emitted by each of these magnets is detectable outside the case of a mobile communication device in which the magnet is employed. Each of these aspects generally requires a magnet to implement the mechanics of the speaker and microphone.

Thus, in a more specific aspect, when a mobile communication device is placed with top end corresponding to the top end of a close proximity device and sufficiently close enough, a sensor, e.g., a magnetic switch, in the close proximity device senses the magnet of the mobile communication device's speaker and the magnetic switch in the close proximity device closes, thereby closing a circuit in the close proximity device. The closed circuit includes a battery and an indicator, e.g., a LED light, whereby the light is now illuminated for the user to see. In an aspect, a close proximity communication tag that requires power to operate is also part of the circuit and thereby provided power when the circuit has closed and becomes operational. The close proximity device may also include a NFC tag, which generally does not require battery power to become operational, but instead relies on electromagnetic induction to operate. Thus, when a mobile communication device is sufficiently close and sufficiently oriented with respect to the NFC tag within the close proximity device, the NFC tag will become operational.

Although an exemplary embodiment discloses a magnetic switch, any appropriate switch can be employed and achieve the desired results. Furthermore, although the described with respect to an indicator being an LED light(s) any appropriate indicator or combination of indicators can be employed and achieve the desired results.

The sensors inside the tag device can tell if a phone or other device that uses close proximity wireless communication is near it and that sensing will that communication will make the tag react. For example, when a tag device senses a device with close proximity communication the tag will react in some way—for example, the tag will light up or make sounds or vibrate or show patterns of light using LEDs or neon or laser light or other visual means. The tag device can also vibrate or make sounds based on different patterns that can be predefined for that specific tag. Conventional NFC tags do not have such interactive elements or reactive features to reflect, by using, for example, visual or auditory or haptic feedback, when an NFC device is nearby or on the tag.

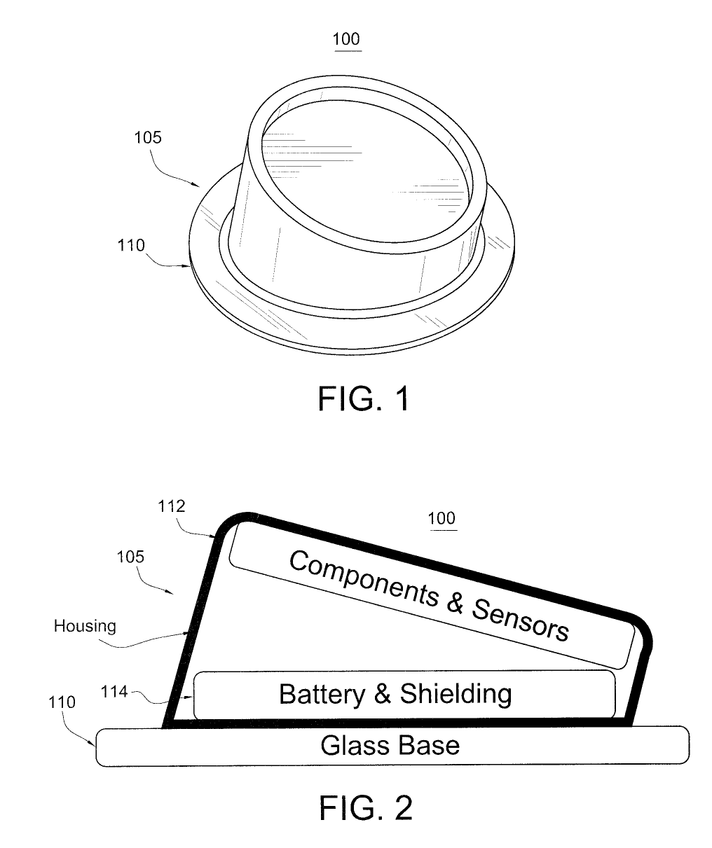

FIG. 1 depicts a perspective view of a close proximity device in accordance with an exemplary embodiment of the invention. As seen in the figure, the close proximity device includes a substantially cylindrically shaped housing 105 that sits atop of a disc shaped base 110.

FIG. 2 depicts a side, cut away view of the close proximity device of FIG. 1. As can be seen in FIG. 2, the close proximity device includes four components: a housing component 105, a communication component (also known as the components and sensors component) 112, a battery component 114, and a base component 110. The communication component 112 includes the sensor, indicator, and communication elements of the exemplary invention. The battery component 114 includes the batteries used to power the elements of the communication component 112. The housing 105 is used to house the communication component 112 and the battery component 114 and is disposed on the base 110. These components are described in greater detail below.

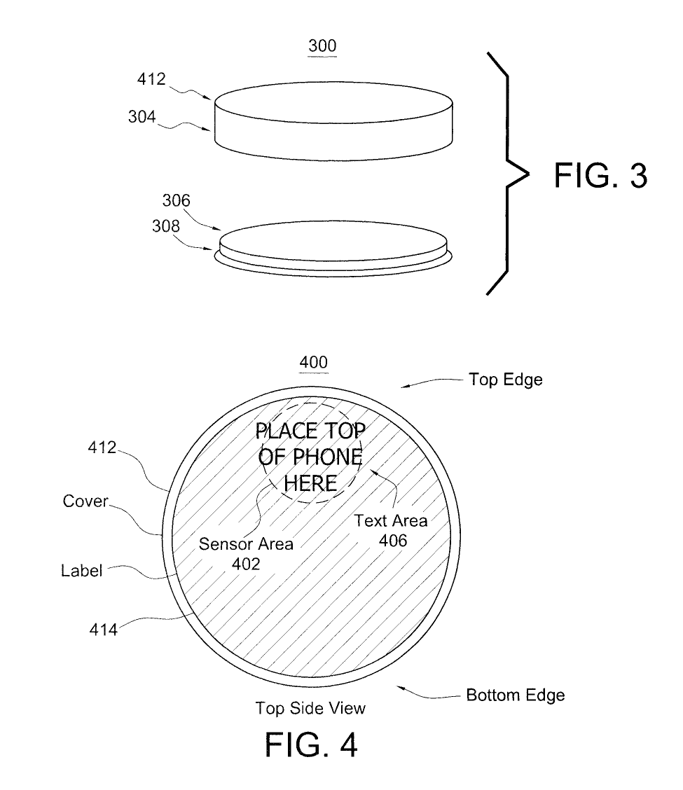

FIG. 3 discloses an exemplary communication component housing 300. As seen in the figure, the component includes a housing comprised of a clear acrylic disk having a removable top portion, or cover/lid, 312 and a bottom portion, side-walled dish, or dish 306. In an aspect, the top portion has an approximate diameter of 71.37 mm and has a sidewall 304 height of 12.89 mm. The top portion 302 nests over the bottom portion 306. An exemplary embodiment employs an Air Tite™ coin housing style Y63 from Air-Tites™ which provides a substantially air tight compartment.

When assembly has been completed, an exemplary communication component 300 includes at least one close proximity communication tag, a sensor and an indicator. In an approach, the communication component 300 includes substantially within its housing two close proximity communication tags: an NFC tag and a Bluetooth BLE tag. In this implementation, communication can be provided by the close proximity device to most mobile communication devices employing either NFC communications, Bluetooth BLE communications, and/or a combination of both. Other implementations of the close proximity device may employ only one close proximity communication tag or other combinations of different close proximity communication tags. A component housing can be, for example, an air tight compartment.

FIG. 4 depicts a top side perspective looking down through a cover 412 of communication component 400. The top portion 412 includes a label 414 that fits into the interior of the top portion 414. As seen in FIG. 4, the label 414 has a top side and a bottom side, and having a top edge and a bottom edge. On the top side displays information including an indication to a user that top the user's phone should be placed corresponding to a location of the text “PLACE TOP OF PHONE HERE” in text area 406 on the top side, typically towards the top edge of the label. This location corresponds to the sensor area 402 which corresponds the location of the sensor in the area below the label in the bottom part of the housing 400, as descried in greater detail below. This text is intended to help a user position her mobile communication device correctly over the tag device.

A preferred reason for this implementation of the sensor area is based on the general design and implementation of a mobile communication device, which has a large magnetic area near the top edge of the mobile communication device due to a magnet in a speaker of the mobile communication device. Many mobile communication devices also have antennae(s) which are also located on backside of the mobile communication device, on the upper portion of the mobile communication device, substantially corresponding to a similar region of the mobile communication device where the speaker is located. When the label 414 placed in the clear housing, the information on the label 414 is visible through the top of the top cover 412.

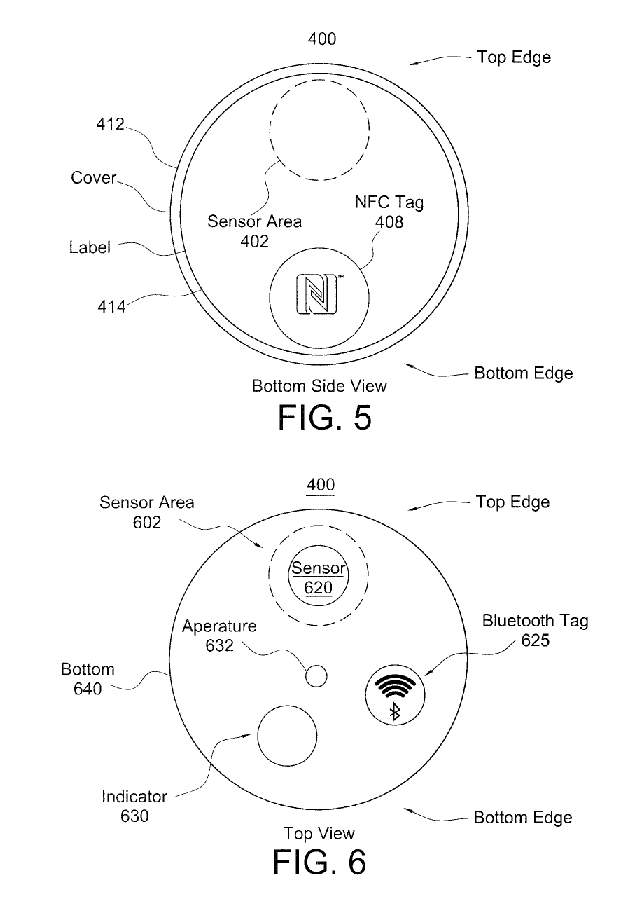

FIG. 5 depicts a bottom up view of the cover of the communication component viewing the back or underside of a label 414. On the back side of a label 414, an NFC tag 408 is applied to the lower portion of the label 414 near the bottom edge and away from the sensor area 402 at the top edge, as described below.

At some time before or during employing the NFC tag 408 onto the label 414, the NFC tag 408 has been modified. One modification to the NFC tag 408 includes providing an application identification to be executed by a mobile communication device. For example, when a mobile communication device communicates with the NFC tag 408 using native NFC communication protocols, the mobile communication device receives instructions to execute a particular app. If the mobile communication device doesn't have the app, the instructions from the NFC tag 408 may also where do retrieve the app from and then the mobile communication device executes the app. A second modification to the NFC tag is identifying information for the NFC tag 408, preferably unique information. A computer database stores the unique information. For example, the unique information as interpreted by a computer program accessing the database provides the location of the NFC, e.g., which chaise located next to which pool on the grounds of which hotel property. A third modification is made to the NFC tag 408 is to lock the tag so that it cannot be reprogrammed.

A top down perspective view of a bottom portion 640 of a communication component housing 400 is depicted in FIG. 6 which has a sensor 620 in a sensor area 602, an indicator 630, a Bluetooth tag 625, and an aperture 632. The sensor 620 is a magnetic switch which when is in a magnetic field, the switch closes completing an electric circuit. The magnetic switch 620 employs a N52 natural earth magnet (size and dimensions) within an O-ring on the bottom portion. When the magnet is at rest and not in a magnetic field or attracted to a metallic substance, the magnet sits on the bottom portion. When a magnet is exposed to a magnetic field, or a metallic object, above it and the field is greater than the pull of gravity down on the magnet then the magnet is pulsed up. The top of the magnet is coupled to one leg of a circuit, e.g., by fastening a portion of a copper sheet to the top of the magnet. Another leg of a circuit is coupled to another copper sheet that is above the first copper sheet. When the magnet is at rest, there is a gap between the first a second sheet and therefore the circuit is open. When the magnet has been pulled up, a portion of the copper sheet fastened to the magnet is pulled up and placed in contact with a portion of the second copper sheet, thereby closing the circuit. Thus, compatible mobile communication devices include a localized magnetic region in a top portion of the mobile communication device which is effective to activate the magnetic switch and cause power up when the mobile communication device is placed sufficiently close enough and sufficiently oriented to the magnetic switch. The copper employed for the copper sheet fastened to the top of the magnet will flex through use as the magnet raises and lowers, and as such, a pure or substantially pure metal element would likely become brittle and break or become fatigued over time. As such, in an exemplary device, the copper sheet is a tape consisting a copper foil backing coated with conductive acrylic pressure sensitive adhesive. It has a carrier thickness of 0.025 mm, and a total thickness 0.06±0.005 mm. This type of construction has a reduced likelihood of oxidation and has an expected electrical resistance of 0.05 ohm/int. It has a holding power of greater than 1140 kg/inch and a peeling Strength greater than 8 N/25.4 mm. The copper employed for the portion disposed over the O-ring in the exemplary embodiment is a 99.90% pure copper, non-magnetic, highly conductive, corrosion-resistant metal Annealed, or softened, to restore formability.

Although described with respect to a magnetic switch, any appropriate switch mechanism can be employed, including, but not limited to, a reed switch or a hale switch. In other applications, other implementations of sensors can be used, for example, a radio wave responsive sensor, e.g., an NFC tag, can be used to sense for an mobile communication device. Other implementations of sensors include sensors responsive to sound and/or light.

In a preferred approach, a custom made neodymium N52 magnet is employed having a unique thickness (⅛″) and diameter size (⅝″). Through experimentation, the inventor determined that this would be a desirable product to use. As is well known, the N52 magnet is a powerful magnet. Employing such a powerful magnet required employing a barrier that would reduce the likelihood that the magnet would be attracted the other components in the disc. Through experimentation, the inventor determined that this O-ring would be a desirable approach to follow. The magnet is placed in direct center of the O-Ring. The rubber of the O-ring is non-magnetic, yet has some properties to block small levels of the magnetic field. The curved inside edge of the O-ring provided a mostly frictionless barrier as the more the more surface area around, the more likely the magnet might bump or drag due to wall friction.

In application a switch was required that had a very small tolerance, with a z axis movement of approximately 1 mm. The inventor's investigation determined that a combination of industrial adhesive to properly bond to the magnet, and to bond the magnet to a copper swing arm and tried employing a copper swing arm which provided rigidness in the X Y axis, but consistent flexibility in the Z access. The copper sheeting for the swing arm desirable had to have the right Gauge value to provide a certain level of flexibility but also be thin enough to slide into the floating chamber. It would also be desirable that the copper sheeting also had to be able to high resist tearing and be able to reasonably keep its rigidity level for a long time, e.g., years of motioning up and down. I found that copper sheeting and adhesive that would work in the floating chamber.

The floating chamber is composed of the rubber O-ring walled, and partially capped at the top with a different, highly conductive copper covering that partially covers the O-Ring. This roof of the floating chamber is mounted down from a distance to the O-Ring walls, and is connected to one of the battery leads. The bottom of the chamber is the industrial acrylic of the communications housing. It is referred to as a floating chamber because from below and above of the magnet, there is an air gap. This air gap reduces the likelihood of any ferrite material interfering with the magnet to reduce or redirect the magnetic field. Ideally, the gap is so sufficient such that communication housing that includes the magnetic switch can be placed on a metal surface and the surface won't affect the magnet by pulling it down. In a preferable approach, the magnet is adjusted to float, with just enough ferrite material to counteract the gravity. The copper arm is designed to have a reduced rigidness, yet still wanted the magnet to be in as frictionless position as possible. The inventor determined placing some ferrite above the magnet to keep it at a floating position. Any interruption from a magnetic field from the top, such as a phones antenna or a powerful magnet located on a phones speaker or microphone would attract the floating magnet and create the closed surface.

In an exemplary invention two LED lights are used an indicator 630, although other indicators can be employed. In an aspect, the LED lights are positioned such that the diode aspect of the lights are on the underside of the bottom portion 640 and are directed downward and the leads of the LED lights are brought back through the bottom portion to be part of the circuit. When the circuit is completed in the invention, the LED light illuminate, the light from the LEDs is directed downward, passes through the transparent areas of the invention and is refracted within the glass base. As a result, then the LEDs illuminate, the glass base will appear to glow light in the color of the LEDs.

The bottom portion 640 also includes a Bluetooth tag 625 is electrically coupled to the circuit formed by the sensor 620, the indicator 630, and a battery, described below. The exemplary invention uses a SticknFind TNC065C Bluetooth tag, however the invention is not so limited and other Bluetooth tags can be employed and achieve the invention. In the exemplary invention, the Bluetooth tag, which is an aspect, it is operating as an iBeacon, has been modified to exclude an external housing, to include connection point electrical leads, it has been shrink wrapped in a nonconductive material on only approximately half of the tag and not wrapping the part of the Bluetooth tag where its antennae is located. Additional customization been applied to the software of the tag, including having the manufacture program designated major/minor values and the settings for broadcasting and advertising. In at least one other exemplary invention employs a Bluetooth tag from another manufacturer to achieve the invention.

In certain embodiments, an assembly prepared according to principles of the present invention includes a Bluetooth tag 625 configured for a particular customer application. In certain embodiments, configuration of the Bluetooth tag 625 is accomplished during manufacture of the tag. In other embodiments, configuration takes place immediately prior to insertion of the Bluetooth tag 625 into a corresponding housing during assembly of a particular device. In still further embodiments, configuration of the Bluetooth tag 625 is achieved after completion of device assembly, and at any convenient or appropriate time including, without limitation, immediately after the completion of assembly, upon receipt of a customer order, immediately prior to shipment of a device, upon receipt of a completed device at an intermediate facility (such as that of a distributor, salesperson, or installation technician), and after receipt of a completed device at a customer location. At some time before or during placing the Bluetooth tag 625 into the container, the Bluetooth tag 626 has been modified. One modification is that the transmission power of the Bluetooth tag 625 reduced to much lower level than standard, e.g., for a transmission range of only a few centimeters; as such, the transmission is limited to a range of within 1 to 2 inches. The Bluetooth tag 625 has also been modified the transmission cycle to very high, e.g., 10 times per second or higher, thus to repeat multiple times a second the broadcast pairing so as to initiate pairing for communication near instantly. These two modifications have the collateral effect of reduces the power consumption of the Bluetooth tag 625.

An additional modification to the Bluetooth tag 625 includes providing an application identification to be executed by the mobile communication device. For example, when a mobile communication device communicates with the Bluetooth tag 625 using native Bluetooth communication protocols, the mobile communication device receives instructions to execute a particular app. If the mobile communication device doesn't have the app, the instructions from the Bluetooth tag 625 may also where do retrieve the app from and then the mobile communication device executes the app. A second modification to the Bluetooth 625 tag is identifying information for the Bluetooth tag 625, preferably unique information, e.g., “major” and “minor” information as defined by Bluetooth protocols. A computer database stores the unique information. For example, the unique information as interpreted by a computer program accessing the database provides the location of the Bluetooth, e.g., which chaise located next to which pool on the grounds of which hotel property. A third modification is made to the Bluetooth tag 625 is to lock the tag so that it cannot be reprogrammed. Furthermore, the Bluetooth tag 625 is modified to be password protected and encrypt the communications for all of the wireless communication.

The bottom portion 640 includes an aperture which is used to pass wires through the bottom of the disk to the battery component of the exemplary invention.

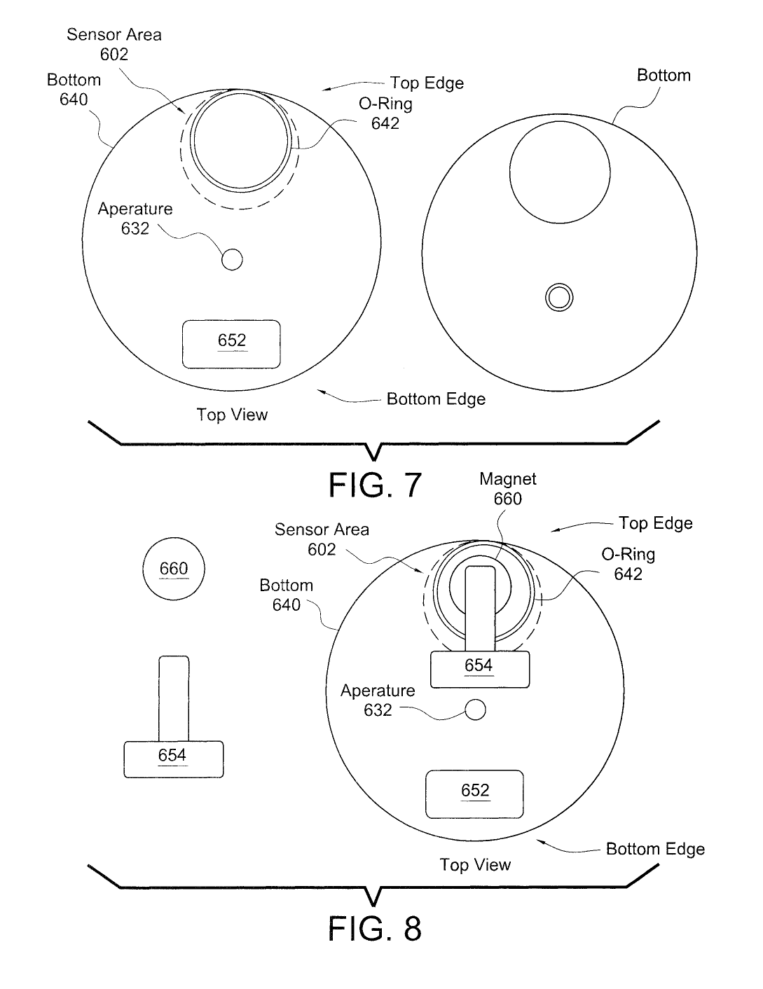

FIGS. 7-11 depict an exemplary method of forming the communication component. As depicted in FIG. 7, an O-ring 1″ outside diameter 642 is secured to the top edge of the bottom portion 640, preferably using a hot glue. In many approaches, it would seem advantageous to include to fasten the O-ring 642 to the top sidewall, with an alligator clip, for example, to hold the O-ring 642 in place while securing it. Then glue a portion of a copper strip near the bottom edge of the bottom portion 640. Then, form an aperture approximately in the middle of the bottom portion 640.

As depicted in FIG. 3b, a magnet 660, preferably an N52 magnet as described above, is glued to a tongue portion of “T” shaped copper sheet 654. Then the magnet 660 is placed in the center of the O-ring 642 on the bottom portion 640 with the copper sheet being on the topside of the magnet. The other end of the copper T shaped sheet 654 is fasted on the bottom portion 640. A guide may be employed to assist in centering the magnet in the O-ring.

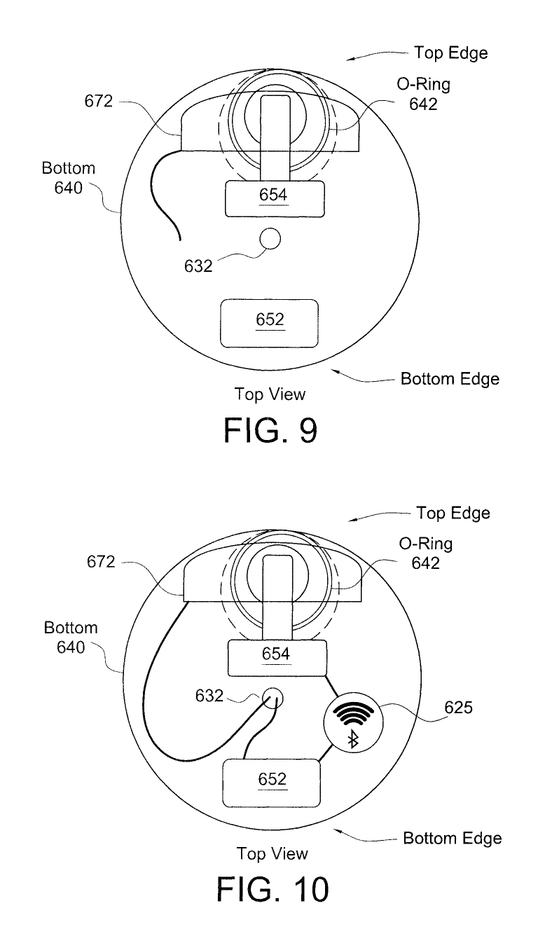

FIG. 9 depicts the bottom portion 640 having an arch shaped copper portion 672 over the O-ring 642. A wire is soldered to the copper sheet 672 solder al wire to an arch shaped piece of copper sheet 672, and then the copper sheet 672 is fastened to the bottom portion 640 over the O-ring 642 having a gap in between the T shaped sheet 654 and the arch shaped portion 672. The gap between the sheet 654 and sheet 672 in a preferred approach approximately 1 mm, but can be configured to different distances as appropriate for the context and implementation.

FIG. 10 depicts a top side perspective view of the bottom 640 now having a Bluetooth tag 625 included. The lead wires of a Bluetooth tag 625 are soldered to the copper T sheet 654 and copper sheet 652, respectively. The other wires form the cooper sheet 652 and copper sheet 672, respectively, are placed through aperture 632 which will be, at a later time, coupled to the battery source, to be described below.

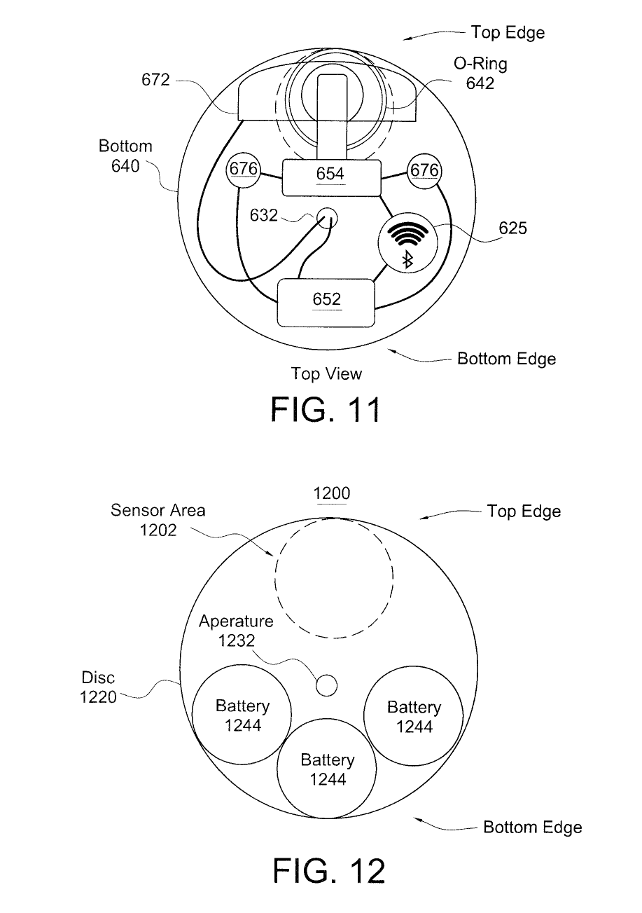

FIG. 11 depicts a top side perspective view of the bottom 640 now having indicators—LED lights 676—included. In FIG. 11, two apertures (not shown for simplicity) are formed in the bottom portion 640. The diode, or head, of the LED lights 676 are passed through the apertures, respectively, such that the diode part of the LED light is underneath the bottom portion and the leads of the LED are on top of the bottom portion, respectively. The leads of each of the LED lights 676 are respectively soldered to the copper T sheet 654 and copper sheet portion 652 at the bottom edge of the bottom 640.

FIG. 18 depicts a slightly exploded, cutaway view of a communication component. The cover 412 is depicted above bottom 640, although in implementation after the internal assembly has been completed, the cover 412 is placed over bottom 640 such that the underneath portion of the cover 412 is substantially resting on the top of the sidewalls of the bottom 640.

FIG. 12 depicts an exemplary battery housing component 1200. The battery component 1200 includes the battery(ies) used to power an exemplary embodiment of the invention as described herein. In this implementation, three CR 2450 batteries 1244 are wired in parallel, typically using small copper sheets (not shown for simplicity) to maintain a low profile, and then the batteries 1244 are fastened to a transparent acrylic disk 1220. One of the batteries 1244, preferably the center of the three batteries 1244, is appropriately connected to the wires extending through the aperture of the communication component described above. (Not shown in the figure for simplicity.) The acrylic disk 1220 also includes an aperture 1232 which is used to fasten the disk 1220 to a base. The aperture 1232 during the assembly of the exemplary invention is used to receive a barrel nut, having its opening facing downwards. During assembly of the exemplary invention, after the battery component 1200 has been fastened to the internal walls of the housing, fastening the disk 1220 to the base will, in effect, secure the base to the housing.

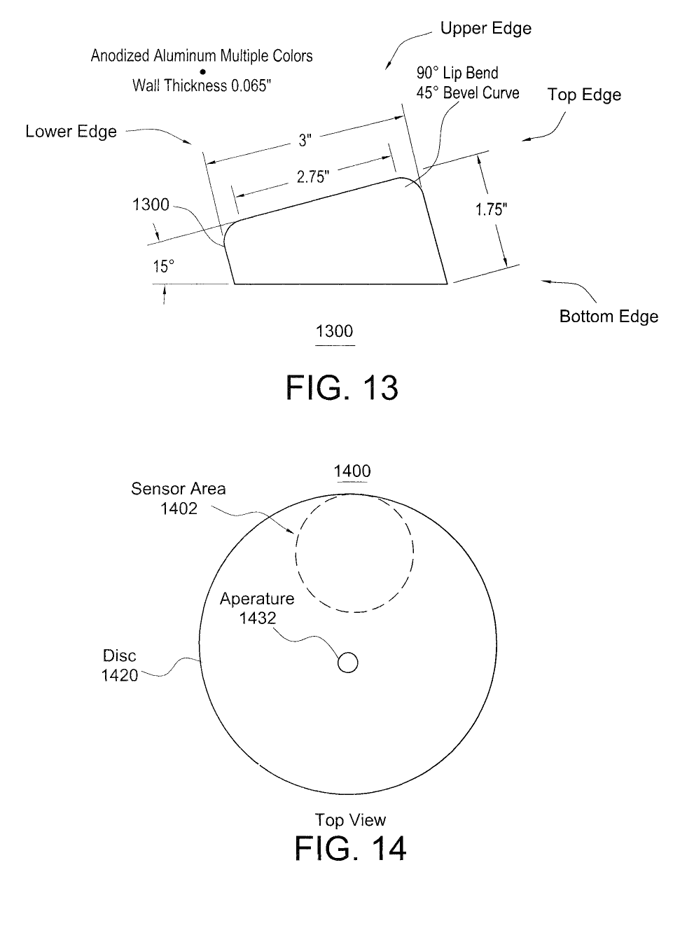

FIG. 13 depicts an exemplary housing component 1300. The housing component 1300 is a tube shaped portion fabricated from aluminum. The tube has a three (3) inch diameter with no lip on the bottom edge of the tube and a 90 degree lip bend having a 45 degree bevel curve on the top edge. The lip of the top edge of the housing is formed such that there is a two and three quarter (2¾) inch diameter aperture on the top edge. The tube of the housing 1300 is formed such that it is substantially trapezoidal in shaped when viewed from the side, having a height of one and three quarter (1¾) inches on an upper side and sloped down at a 15 degree angle resulting in a height of 8 tenths of an inch on the lower side of the tube. Although described with respect to being formed from aluminum, any appropriate material and color can be employed.

FIG. 14 depicts an exemplary base component being a circular disk being approximately four (4) inches in diameter and having an aperture in the center of the disk and ¼ inch in height. In the exemplary case, the base is formed from transparent glass or plastic. The aperture 1432 is used during assembly of an exemplary invention to receive a barrel bolt (shown below) to be fastened with the barrel nut (as described above) to secure the base 1400 to the housing 1300 by way of the battery component 1200.

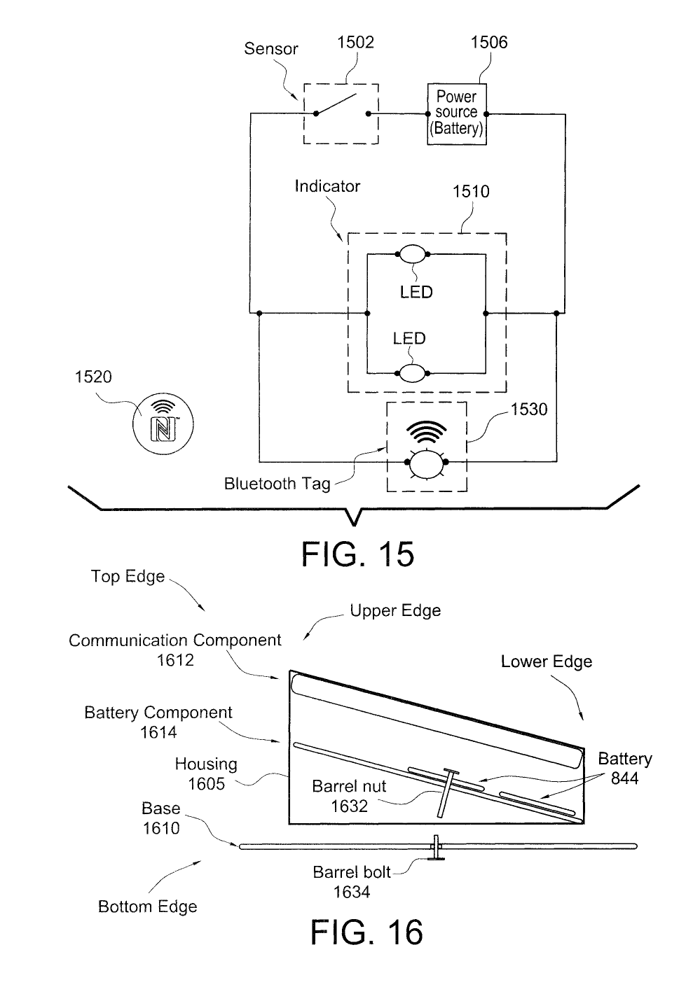

FIG. 15 depicts a representational circuit diagram of the exemplary invention. On the left side of the figure is the NFC tag 1520 which is generally operated independently of another circuitry. On the right side of FIG. 15 is the sensor and Bluetooth circuit. As is apparent, when the sensor 1502, e.g., a magnetic switch, is closed, by the magnet physically closing the circuit by lifting up the lower copper sheet to arch shaped copper sheet overlaying the magnet. When the circuit is closed, power from the power source, e.g., the batteries 1506 in the battery component, is provided to the Bluetooth tag 1530 and the indicator (LED lights) 1510. The powered indicators 1510 illuminate. The powered Bluetooth tag 1530 becomes operational.

FIG. 16 depicts the side view, cut through perspective of a mostly assembled exemplary embodiment of the invention. In exemplary approach, the exemplary embodiment would be assembled as such after the four individual components have been at least partially assembled. In general, assembly of an embodiment would occur as follows:

Step 1. Place communication component housing into housing. The top, upper edge of the housing should be substantially aligned with the center of the sensor in the component housing. Fasten the component housing to internal wall of the housing.

Step 2. Solder the wires from the communication component housing and couple, e.g., solder, them to the center connector points of the battery component.

Step 3. Insert Barrel nut through aperture in battery component and fasten the nut to the component.

Step 4. Place battery component into housing. The battery component should be oriented such that the batteries are substantially evenly placed below the LED lights. Further the batteries should be oriented corresponding a lower portion of the housing and preferably not blocking the sensor.

Step 5. Fasten the base of the battery component to the internal wall of the housing.

Step 6. Fasten the base to the housing by inserting a barrel bolt through the aperture in the base and mating it with the barrel nut described above protruding through the battery component.

At the conclusion of these assembly steps, an exemplary close proximity tag device is ready to be employed. With the sealing of the components in the housing, the tag device is reasonably weather resistant. The exemplar tag device is raised from the surface of placement by between 1 to 12 mm, allowing still a low profile but raising the actual close proximity communications to have not only a plastic housing to protect it, but more importantly, an air pocket gap formed by and between the internal components of the tag device. The air gap allows lets temperature issues such as heat to dissipate more easily. This air gap also gives a more efficient and less costly method of making close proximity communication tags be placed on metal surfaces because of the air pocket.

During exemplary operation, when a mobile communication device is substantially, correctly positioned and oriented over a tag device, the sensor senses the mobile communication device and the magnet closes the switch, thereby completing the circuit. The completed circuit enables the indicator, the LED lights, to illuminate. Based on the construction, the light from the LEDs travels down the interior of the housing and into the glass or plastic base, which has the effect of lighting up the base or making it “glow.” The glow of the base can be perceived by the user providing feedback to her that she has substantially positioned and oriented the mobile communication device correctly which enables her mobile communication device to pair, through close proximity communication, with close proximity communication device(s) within the tag device. Although depicted as a glow, any number of various implementations of lights and/or other indicators can be employed and achieve the invention.

In an aspect, even though the housing can be mostly built of metal, but the way the close proximity communication chip is placed in the housing with the air pocket, there is no direct contact with the metal housing so finally neck tags can come in metal housings and a variety of possible materials. The positioning of integrated circuit and medial location within the communication component so that an air gap exists above and below the electronics which provides substantial thermal insulation, protecting the electronics from thermal shock and extending the life of the device.

In an aspect, an desirable diameter size, i.e., the width, for a tag device is between 50 to 90 mm wide as to correspond to the current average width of a mobile communication device; as time goes on, the average size of a mobile communication device might get larger or smaller and therefore the corresponding desirable size of the width of a tag device might change. The width is desirable because many close proximity communication mobile communication device have their close proximity communication, and more specifically, the NFC antenna and/or Bluetooth antenna, can be generally found in the middle and upper portion of a mobile communication device. For example the iPhone six has antenna on the top of the phone while the Samsung Galaxy five has the antenna towards the middle lower part of the phone. Most conventional NFC tags are paper thin and usually a small diameter so the user doesn't really know where to tap their phone to get an optimal read. The majority of smart phones have an average back width around 70 mm. The size of the tag device is between 50 to 90 mm allows a more natural sizing for the phone to be placed on top of the tag and more likely that the phone will read that NFC signal from the tag.

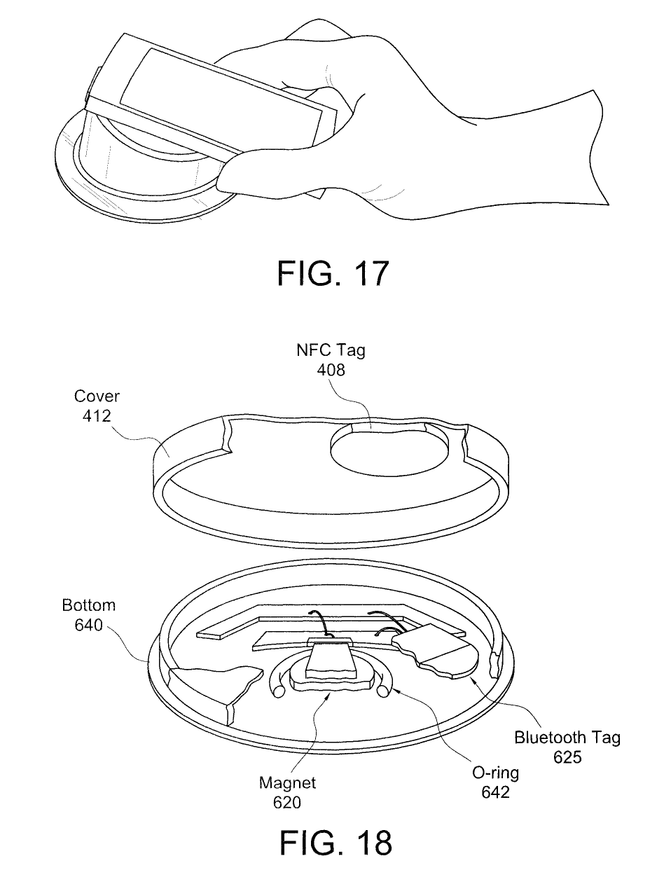

The exemplary tag device is also raised slightly so that a consumer is more naturally prone to lay the phone on the tag instead of trying to wave nearby where it more than likely is too far away from the conventional NFC tag to be read. See, for example, FIG. 17, which depicts a user positioning and orienting a mobile communication device over an exemplary device. As seen in the figure, the top portion of the mobile communication device is substantially positioned and oriented so that it corresponds and substantially overlays the top portion of the tag device. Further, the bottom portion of the mobile communication device is substantially oriented over the bottom portion of the tag device.

While conventional NFC tags are generally paper-thin or slightly thick, the exemplary NFC tag device is raised from a few millimeters or higher so that its a more natural and comfortable position for the consumer to lay their phone on the tag rather than try to waive or tap it on a tag as it is traditional today.

An exemplary tag device has the ability to include an NFC chip or full reader built in to the unit allowing true communication rather than simply reading an identifier. This allows the tag device to offer different services depending on whom, what, when, where are tag is when communicating with a mobile device. When knowing such information, the tag device will react with light or sound or haptic feedback uniquely to one device versus another device. This also gives the tag device the ability to communicate dynamically using unique encryption keys for point to point encryption, instructions, give localized apps, and more.

Exemplary tag devices contain multiple types of communication technologies in addition to or in lieu of conventional NFC. For example, the tag device contains BLE Technology but modified for close proximity to allow older non-NFC phones to have similar NFC experience which allows older phones to benefit from the touch paradigm as they eventually do upgrade to their next phone which will highly likely be a true NFC. Another technology is Wi-Fi to allow it to communicate to other tags or a central hub as a communications port. The Wi-Fi is dynamically encrypted point to point using NFC in the exemplary tag device and an NFC reader in the hub device so that the initial exchange of keys for point to point encryption is established by very close proximity. Exemplary tag devices may also include a fourth wireless technology which is not short range but long-range known as RF ID. This capability allows the tides to be monitored it three-dimensional space so that you know where the times are and if they have been moved or are moving.

This unique design of the improved tag devices allow for a more secure, more intuitive, and more interactive experience when using NFC and other close proximity communications, as well as allowing for other technologies to be used so as to give devices without NFC the experience and most or all the benefits of NFC Until those devices are replaced or upgraded to become NFC capable. In an example, tag devices are discs which are 2 inches in diameter, on purpose. An NFC tag is typically about one half inch in diameter, and the inventor has observed that, as conventionally applied, a user is likely to simply wave a smart phone in proximity to the tag. The present invention reflects the inventor's novel understanding that, if the tag is incorporated in a device that is nearly as wide as the back of a user's smartphone, the user will intuitively understand that he or she should place the back of the phone aligned, and in contact, with the device.

As exemplary tag device use a new generation of security referred to as Quantum Security. With point to point encryption, the same level of what the NSA uses for Top Secret Documents or above, employing anti-snooping technology and designed to protect against even future quantum computing attacks.

This invention creates a huge efficiency for the battery and battery life. Most small Bluetooth devices have batteries that last a few months and need to be replaced. The invention only activates the Bluetooth only when the exemplary tag device senses an close proximity mobile communication device on it, and so extends the battery life/efficiency of Bluetooth device from months to much longer, possible as many years.

Most NFC tag devices only have a small protective film to protect it from water, but very little to protect it from environmental issues such as temperature, scratching the antenna, being placed on metal surfaces, and more. In this exemplary invention, the tag device has increased the protection for the close proximity tags as well as increased insulation from the elements.

Using Creating Revolution's “bridge” and link technologies to let updates and direct communications with the chip to be done via a secure channel of the consumers phone, so remotely updating the chip would not require a wireless connection such as Wi-Fi or requiring some maintenance person to come by, since the next time a consumer uses a custom employed NFC chip, than can be helping to also update the software, without even knowing that they had done so. In an aspect, the user's mobile communication device act as a bridge. The bridge can be employed for a variety of tasks, including software updates and information content for the NFC tag, but also for content such as URLs, or video/audio/images if the tag is connected or has integrated a screen or speakers.

An exemplary tag device can have add on modules connected to it, without requiring direct ports. The connections of power and communication are done wirelessly thought a near field induction process. So the module could be a simply to implement add on battery or could be a set of speakers add on that receive power exemplary tag device via NFC as well as communication from the exemplary tag device via exemplary tag device.

An exemplary tag device can be sized in a way that allows to easily integrate things like solar panels, heat collectors, or other environmental energy generators so that it can add power to the unit to enhance further efficiency of the battery.

An exemplary tag device can incorporate a powerful magnet to enhance the power of its induction field as well as be used as a trigger or switch. This magnet is also important for situations of tag to tag communication. For example, the current iPhone 6 does not have an NFC tag reader, only a tag that emulates. It requires a reader to receive the induction field to wake up and power that NFC chip in the iPhone 6. The exemplary tag device can integrate a NFC/close proximity communication reader but employing a reader would likely increase costs and decrease power efficiency. An exemplary embodiment uses specialized magnet that allows an induction field that gives power to both the NFC chip in the tag device, as well as the NFC chip in the iPhone. Once both chips are powered via the magnetic field, then both chips have the ability to communicate RX/TX via radio frequency. This allows for both NFC chips to communicate without requiring the traditional NFC reader/writer that must electrically generate the magnetic induction field.

An exemplary tag device can employ Creating Revolution's virtual bucket technology with the dynamic IDs and dynamic encryption keys being given in close proximity for true constantly changing Point to point encryption. The phone of the consumer is used as a bridge to be able to communicate over to the exemplary tag device for both RX and TX. The encryption keys are placed in the management virtual bucket which only one person can take out and then it automatically is filled based on the methodology of Creating Revolution's Virtual Bucket™ technology. So every new person who taps and accesses that virtual bucket is grabbing a new encryption key and bucket ID as well as any other identifying or security information for that singular communication between the retailer and the consumer at that specific place and time. The phone can also be used as a channel so that it fills in the next potential keys into the exemplary tag device. The key on the security is based on the idea of exchanging the encryption keys, Directory, server, filename, etc. of that singular exchange between that mobile device of the consumer and the tag placed in the retailer so that only the two of them know all this information for that one single exchange and nothing is kept in the cloud that can be stolen and its basically impossible to snoop on. The keys can also be given via a short range technology such as Bluetooth or Wi-Fi or directly coupled to secondary device or directly connecting to the Internet or network where the keys can be supplied to the tag via that method as well. But always the keys and dynamic bucket IDs, etc. are only exchanged at a very close proximity of within 1 to 2 inches between the consumer's mobile device and the exemplary tag device so its basically impossible to listen in and know all that in from and basically impossible to know where that information is where its going what it is or the encryption of it. Every time any consumer taps, they get a whole new set of information given in close proximity to. Even the same consumer if tapping their mobile device again either now or at a later time and date to that same exemplary tag device or a different one will not get the same information for communication and security. Each interaction each time for any of the tag devices create a unique set of dynamic bucket IDs and encryption keys for that one communication session and its always temporary and untraceable.

While the invention has been described and illustrated with reference to specific exemplary embodiments, it should be understood that many modifications, combinations, and substitutions can be made without departing from the spirit and scope of the invention. For example, an operation described as occurring in software is not necessarily limited to be implemented in software and can be partially, substantially, or completely implemented in hardware. Similarly, an operation described as occurring in hardware is not necessarily limited to be implemented in hardware and can be partially, substantially, or completely implemented in software. Furthermore, although NFC is used in several of exemplary aspects described above, the invention is not so limited and other communication technologies can be utilized, for example, but not limited to, barcodes, Bluetooth, and Wi-Fi. Furthermore, while exemplary aspects depict an invention using a mobile phone as a type of mobile communication device, the invention is not so limited and can be other types of computing devices, for example, but not limited to, a tablet computer, laptop computer, a personal computer and any other computing device that a consumer can use. Although the invention is described with respect to using LED lights for a visual indicator, the invention is not so limited and other indicators and combination of indicators can be employed. For example, digital ink or electro luminescence panels can be employed for other visual indicators. Various haptic or audible components can also be employed.

Accordingly, the invention is not to be considered as limited by the foregoing description but is only limited by the scope of the claims.

What is claimed as new and desired to be protected by Letters Patent of the United States is:

1. A close proximity tag device for providing an indication of a mobile communication device being substantially correctly oriented and positioned with respect to, said device comprising:
a sensor for sensing a mobile communication device; and
an indicator coupled to said sensor, where said indicator is adapted to indicate when said sensor senses a substantially correctly oriented and positioned mobile communication device.

2. The tag device of claim 1, wherein said indicator is a visual indicator.

3. The tag device of claim 1, wherein said indicator is an audible indicator.

4. The tag device of claim 1, wherein said indicator is a haptic indicator.

5. The tag device of claim 2, wherein visual indicator is an LED that is adapted to causes at least a portion of said tag device to illuminate.

6. The tag device of claim 1, wherein said sensor comprises a magnet configured to sense a substantially correctly oriented and positioned mobile communication device.

7. The tag device of claim 1, where said magnet comprises a rare earth magnet.

8. The tag device of claim 1, wherein said sensor comprises a close proximity communication device configured to sense a substantially correctly oriented and positioned mobile communication device.

9. A close proximity communication feedback device for providing feedback when a close proximity device is substantially correctly oriented and positioned with respect to said feedback device, said feedback device comprising:
a feedback indicator;
a switch coupled to said feedback indicator; and a
a sensor coupled to said switch, wherein said sensor is adapted to cause said switch to close thereby completing an electric circuit with said feedback indicator when said sensor senses a substantially correctly oriented and positioned mobile communication device and adapted to not cause said switch to close when said sensor does not sense a substantially correctly oriented and positioned mobile communication device.

10. The feedback device of claim 9, further comprising:
a power source switchably coupled to said feedback indicator through said switch.

11. The feedback device of claim 10, wherein said sensor comprises a magnet.

12. The feedback device of claim 11, wherein said switch further comprises a first leg and a second leg of said electric circuit, wherein when said first leg is coupled to said second leg said electric circuit can become closed.

13. The feedback device of claim 12, wherein said first leg is a first portion of conductive metal and said second leg is a portion of a second conductive metal.

14. The feedback device of claim 12, wherein said first leg is disposed under said second leg, an underside of said second leg being coupled to a top side of said magnet, where feedback device being adapted such that said first leg being coupled to said second leg when said magnet is pulled up, and being adapted such that said first leg not being coupled to said second leg when said magnet is not pulled up.

15. The feedback device of claim 12, further comprising a Near Field Communication tag.

16. The feedback device of claim 12, further comprising a close proximity communication tag switchable coupled to said power source through said switch.

17. The feedback device of claim 16, wherein said close proximity communication tag is a Bluetooth tag.

18. A close proximity communication feedback device for providing feedback when a mobile communication device is substantially correctly oriented and positioned with respect to said feedback device, said feedback device comprising:
a housing, said housing including:
a communication component adapted to sense when a mobile communication device is substantially correctly oriented and positioned with respect to said feedback device and when this is sensed communication component cases a feedback indicator to indicate.

19. The feedback device of claim 18, wherein said communication component further comprises:
a switch coupled to said feedback indicator; and a
a sensor coupled to said switch, wherein said sensor is adapted to cause said switch to close thereby completing an electric circuit with said feedback indicator when said sensor senses a substantially correctly oriented and positioned mobile communication device and adapted to not cause said switch to close when said sensor does not sense a substantially correctly oriented and positioned mobile communication device.

20. The feedback device of claim 19, wherein said feedback indicator comprises a visual indicator.

21. The feedback device of claim 20, wherein said visual indicator comprises a light adapted to illuminate when it is indicating.

22. The feedback device of claim 21, wherein when said visual indicator is illuminated, it is adapted to cause at least a portion of said feedback device to illuminate.

23. The feedback device of claim 21, wherein said housing has a width b being substantially between 50 to 90 mm.

24. The feedback device of claim 15, wherein said NFC tag is adapted to receive information from a mobile communication device.

25. The feedback device of claim 15, wherein said NFC tag is adapted to receive update information for the NFC tag from a mobile communication device.

26. The feedback device of claim 16, wherein said close proximity communication tag is adapted to receive information from a mobile communication device.

27. The feedback device of claim 16, wherein said close proximity communication tag is adapted to receive update information for the close proximity communication tag from a mobile communication device.

28. The feedback device of claim 17, wherein said Bluetooth tag is adapted to receive information from a mobile communication device.

29. The feedback device of claim 17, wherein said Bluetooth tag is adapted to receive update information for the Bluetooth tag from a mobile communication device.
